(19) United States
(12) Patent Application Publication
(10) Pub. No.: US 2004/0221425 A1
(43) Pub. Date: Nov. 11, 2004

(54) Pry bar ergonomic handle

(76) Inventor: John C. Lawless, Charlemont, MA (US)

Correspondence Address: LACKENBACH SIEGEL, LLP, LACKENBACH SIEGEL BUILDING, 1 CHASE ROAD, SCARSDALE, NY, 10583, US

(21) Appl. No.: 10/429,463

(22) Filed: May 5, 2003

(51) Int. Cl. B62B 1/00

(52) U.S. Cl. 16/430

(57) ABSTRACT

A pry bar has an ergonomic handle formed with a grip portion having convex upper grip surface and a concave lower grip with an inner hard thermoplastic core and an outer elastomeric molded over cover. The convex upper grip surface portion is more distantly disposed from the handle longitudinal axis than the curved lower grip surface portion. The upper grip surface is formed with a distally disposed outwardly flared guard formed with thumb receiving recess. The handle sides are formed with elongated outwardly bulged contoured respective palm engaging portions for right or left handed grip engagement.

### BACKGROUND OF THE INVENTION

This invention relates to pry bars and pry bar handles. Specifically, this invention relates to a pry bar ergonomic handle.

### BACKGROUND AND DISCUSSION OF THE PRIOR ART

In general, pry bars were of all metal construction and were cumbersome to grip and use. Often the user has to grip a rectilinear metal portion of the pry bar in use. One such prior art construction is disclosed in U.S. Pat. No. 6,058,809 to Flanz.

A wrecking tool is disclosed in U.S. Patent application Publication No. 2002/0134971 to Christensen. The Christensen tool has an elongate octagonal cross-sectional metal handle or bar stock portion. A non-octagonal handgrip is attached to the octagonal metal bar.

It was generally known to provide a soft elastomeric molded over cover on a molded hard thermoplastic core for improved grip for knives, screwdrivers, and like bladed tools. Such prior art constructions are disclosed in Sanelli, U.S. Pat. No. 4,712,304; Gakhar, U.S. Pat. No. 5,390,572; Hoepfl, U.S. Pat. No. 5,964,009; and Panaccione, U.S. Pat. No. 5,956,799.

The pry bar art desires an improved handle so as to provide improved grip with ergonomic functionality.

It is therefore a principal object of the present invention to provide an ergonomic handle pry bar.

It is another object of the present invention to provide an improved grip pry bar handle.

The aforesaid inventive aspects alone and in combination provide an ergonomic handle pry bar construction.

It is still another object the present invention to provide a pry bar with diverse functionality.

It is still a further object of the present invention to provide a pry bar as aforesaid which is practical in design, manufacture and use.

Present applicant is the inventor of the ergonomic pry bar handle disclosed in U.S. Pat. No. 6,471,186, granted Oct. 29, 2002, which patent and the present application are commonly assigned to Mayhew Steel Products, Inc.

### SUMMARY OF THE INVENTION

A pry bar ergonomic handle has a longitudinal axis and a grip portion having an upper convex surface and a lower concave surface with a recess formed in the distal end of the upper surface to receive the thumb, and the grip portion further includes oppositely disposed bulged sides. The user's grip hand engages the upper and lower surfaces with the palm engaging one of the bulged sides for ergonomic effect in heavy duty pry bar use. The thumb recess is formed in a outwardly flared distal end portion of the handle. The handle has a hard thermoplastic core and an integrally molded over elastomeric material cover. The elastomeric material covers a substantial portion but not the entire grip portion. A metal impact cap is fixedly secured in the proximate end of the handle.

### BRIEF DESCRIPTION OF THE DRAWINGS

FIG. 1 is a perspective view of the pry bar embodiment of the present invention;

FIG. 2 is atop plan view of the pry bar of FIG. 1;

FIG. 3 is a side elevational view of the pry bar of FIG. 1;

FIG. 4 is a bottom partial fragmentary view of the pry bar as shown in FIG. 3;

FIG. 5 is a sectional view taken along line 5-5 of FIG. 3;

FIG. 6 is a sectional view taken along line 6-6 of FIG. 5;

FIG. 7 is a sectional view taken along line 7-7 of FIG. 6; and

FIG. 8 is a sectional view taken along line 8-8 of FIG. 6.

### DESCRIPTION OF THE PREFERRED EMBODIMENTS

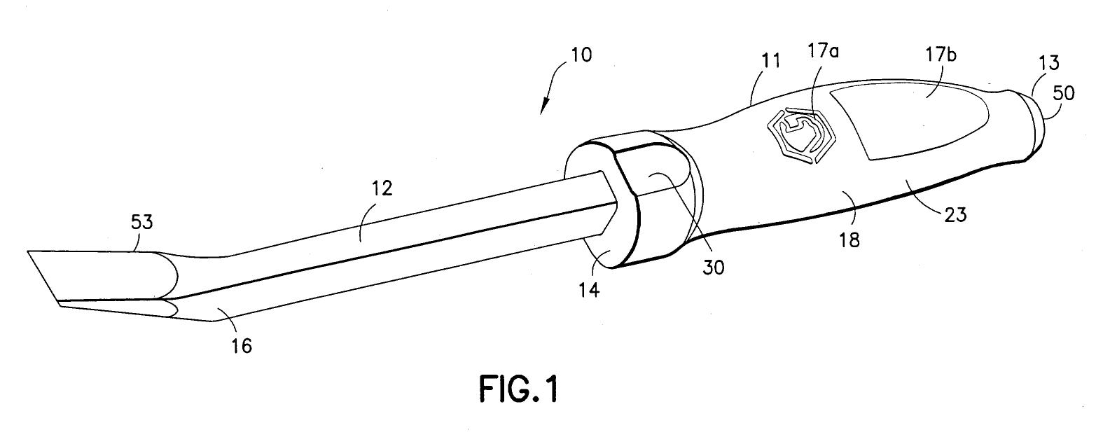

Referring to FIGS. 1-8, there is shown pry bar 10 of the present invention. Pry bar 10, in general terms, includes handle 11 and a fixedly attached metal shank or blade 12. Handle 11 has a proximate end 13 and a distal end 14. Shank 12 has a proximate end 15 and a distal end 16. Handle 11 is formed of a hard thermoplastic molded core 17 and a molded over integrally bonded elastomeric cover 18, wherein cover 18 is formed of relatively soft elastomeric material.

The proximate end 25 of blade 12 is securely fixedly molded in core 17, with the formation of core 17, by means known in the art. The elastomeric cover 18 is then molded over or around the core by means well known in the knife, screwdriver, and like bladed hand tool handle prior art.

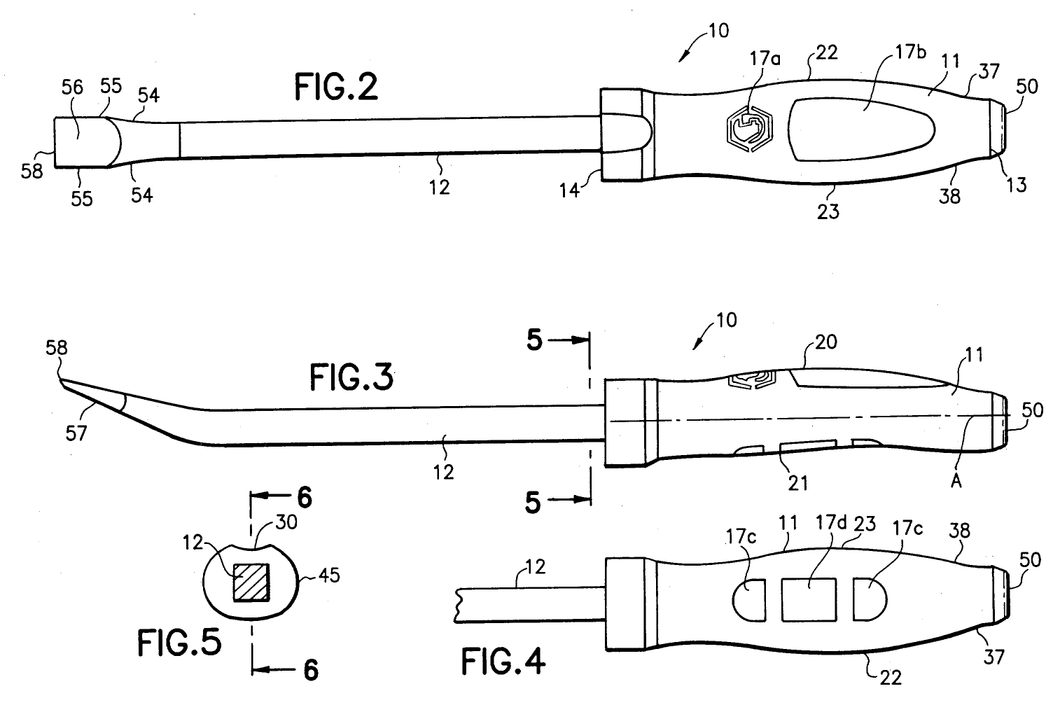

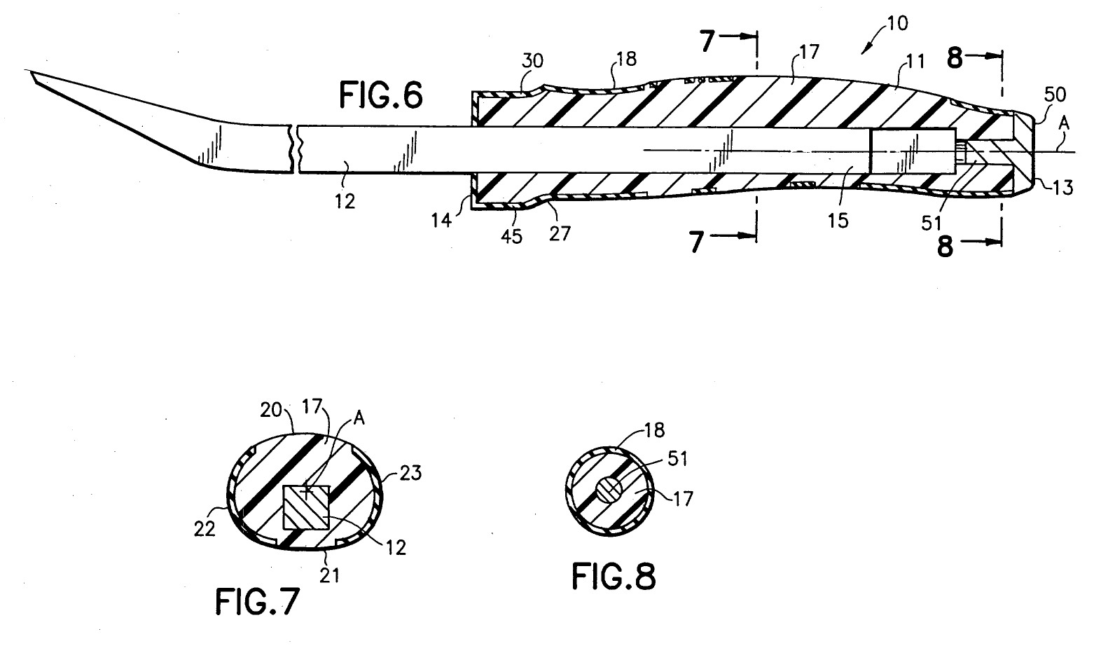

Handle 11 grip portion has an upper grip surface 20 and oppositely disposed lower grip surface 21, and oppositely disposed bulged sides 22 and 23. Handle 11 has an elongated central axis A, as best shown in FIGS. 3 and 6. Upper grip portion 20 is further disposed from axis A than lower grip portion 32. Each handle side 22 and 23 has an outwardly or protruding rounded contour. The sides 22 and 23 are tapered inwardly in the proximate direction as at 37 and 38 respectively, as best shown in FIGS. 2 and 4.

A metal impact cap 50 is fixedly disposed at the proximate end 13 of the handle 11. Cap 50 has a prong 51 which is fixedly secured within the handle core 17, as best shown in FIGS. 6 and 8. Cap 50 is used by way of example, to impact screw heads prior to driving same.

With specific reference to FIGS. 2, 3 and 6, blade 12 is of square or rectilinear cross-sectional metal construction. Blade 12 has a proximate end 15 and a distal end 16. Proximate end 15 is molded in situ with core 17, so as to be fixedly secured within handle 11, by means well known in the art. Blade distal end 16 is formed with a pry end 53. Pry end 53 has outwardly tapered sides 54, and parallel sides 55, and upper and lower surfaces 56 and 57. Surfaces 56 and 57 are distally tapered, and extend towards sharpened edge or tip 58. Tip 58 is upwardly angularly disposed with respect to blank 12. Blade 12 is angularly disposed in handle 12.

In the aforesaid manner of construction, there is provided an ergonomic pry bar and handle. More specifically, the user's palm is partially disposed on the upper grip surface and one of the outwardly bulged or contoured sides (depending upon whether the user is right or left handed), with the fingers generally engaging the oppositely disposed bulged side. The thumb is disposed in recess 30 of distal guard 45. The forefinger is received in recess 27 and retained therein by distal guard 45. Recesses 30 and 27 are covered by elastomeric material cover 18. In the aforesaid manner of construction, the user grips the handle and uses the pry bar with comfort and reduced fatigue as compared with conventional construction pry bars.

The elastomeric cover 18 covers substantially all of core 17, but does not cover the entire core 17. Upper surface areas 17a and 17b and lower surface areas 17c, 17d and 17e are uncovered. Areas 17a-17c are available for permanently imprinting the manufacturers name and for ornamental aesthetic purposes.

The core may be formed of hard thermoplastic using and the cover may be formed of with elastomeric material well known in the hand tool handle art.

The afore-discussed handle surfaces and contours, and in conjunction with the pry bar configuration and disposition with respect to the handle, provides an ergonomic pry bar.

While the foregoing describes certain embodiments of the invention, various modifications and changes may be made within the spirit and scope of the invention, as defined by the adjoined claims.

1. (canceled)

2. (canceled)

3. (canceled)

4. (canceled)

5. (canceled)

6. (canceled)

7. (canceled)

8. An ergonomic pry bar handle comprising:
a handle, said handle having;
a grip portion, said grip portion being formed with
a convex upper grip surface, and
a concave lower grip surface, and
a thumb receiving upper recess, and
a forefinger receiving recessing lower recess;
wherein the thumb receiving recess is distally disposed of said from upper grip surface and the forefinger receiving recess is distally disposed from said lower grip surface.

9. The handle of claim 8, said handle having a longitudinal axis, and wherein said upper grip surface is more distant from said axis than said lower grip surface.

10. The handle of claim 8, said handle further comprising a hard thermoplastic core and an outer softer elastomeric integral cover.

11. The handle of claim 8, said handle having oppositely disposed sides, each said side being formed with an elongated outwardly disposed contoured bulge.

12. The pry bar of claim 8, further comprising a metal impact cap fixedly disposed at the handle proximate end.

13. An ergonomic pry bar handle comprising:
a handle having a proximate end and a distal end and being formed with a through bore extending from the proximate end to the distal, said handle distal end bore being formed to fixedly hold a pry bar blade and said handle proximate end being formed to fixedly hold a metal impact cap; said handle being formed with a grip portion, said grip portion comprising an upper convex surface and a lower concave surface.

14. The handle of claim 13, said grip portion further comprising a thumb receiving surface and a forefinger-receiving surface.

15. The handle of claim 13, further comprising a metal impact cap fixedly disposed in said handle bore.

16. The handle of claim 15, said handle further comprising an inner thermoplastic core comprising said bore, and an outer integrally bonded elastomoric cover said cover comprising a portion of said upper and lower grip surfaces.

17. The handle of claim 16, further comprising a metal impact cap fixedly disposed at the handle proximate end.

18. The handle of claim 16, further comprising said upper surface grip surface comprising a portion comprising said thermoplastic.

19. The handle of claim 18, said thermoplastic upper grip surface portion comprising identifying indicia.

20. The handle of claim 19, further comprising a second upper grip thermoplastic surface.
